(19) United States
(12) Patent Application Publication
(10) Pub. No.: US 2012/0089489 A1
(43) Pub. Date: Apr. 12, 2012

(54) COMPONENT SAFETY INVENTORY AMOUNT CALCULATING METHOD, PROGRAM FOR EXECUTING SAME, AND DEVICE FOR EXECUTING SAME

(75) Inventors: Jun Tateishi, Tokyo (JP); Junko Hosoda, Miura (JP); Satoshi Fukushima, Fujisawa (JP)

(73) Assignee: Hitachi, Ltd., Tokyo (JP)

(21) Appl. No.: 13/141,355

(22) PCT Filed: Dec. 22, 2008
(86) PCT No.: PCT/JP2008/073305

§ 371 Date: Dec. 5, 2011

(51) Int. Cl. G06Q 10/08

(52) U.S. Cl. 705/28

(57) ABSTRACT

A device (100) for calculating the amount of safety inventory of a common component commonly used in products comprises a required-amount deviation calculating section (111) for determining the required-amount standard deviation of the common component using the demand standard deviation of each product, an integrated required-amount deviation calculating section (112) for determining the required-amount standard deviation of the common component of all the products as an integrated required-amount standard deviation using the required-amount standard deviation of the common component of each product, and a safety inventory amount calculating section (116) for determining the safety inventory amount of the common component using the integrated required-amount standard deviation. The integrated required-amount deviation calculating section (112) has a correlation coefficient calculating block (113) for determining a correlation coefficient representing the correlation among the required amounts of the common component of the products from the past records of the required amount of the common component of each product and a primary integrated required-amount standard deviation block (114) for determining an integrated required-amount standard deviation using the correlation coefficient and the required-amount standard deviation of the common component of each product.

### TECHNICAL FIELD

The present invention relates to a technique of calculating a safety inventory amount of a component that is used commonly in a plurality of products.

### BACKGROUND ART

Speeding-up of computers has allowed development of an apparatus for calculating a safety inventory amount of a component according to a certain method even in the case where a product is composed of a large number of components.

For example, Patent Document 1 describes a method in which a computer system is used to calculate a required-amount standard deviation concerning time variation of a required amount of each component for each product on the basis of a demand standard deviation concerning time variation of demand for each product and components configuration information of each product, and to calculate a safety inventory amount by using the obtained required-amount standard deviations, safety coefficients and the like.

Patent Document 1: Japanese Unexamined Patent Application Laid-Open No. 2007-128225

### DISCLOSURE OF THE INVENTION

### Problems to be Solved by the Invention

It is certain that the technique described in the above Patent Document 1 can obtain a safety inventory amount of a component with some degree of accuracy. Nevertheless, a manufacturer that produces a product always desires to obtain a more accurate safety inventory amount of a component so as to reduce excess or deficiency of the component as far as possible.

Thus, to respond to this request, an object of the present invention is to provide a technique of obtaining a safety inventory amount of a component more accurately. Means to achieve the object

To achieve the above object, the present invention is characterized in executing the following (1)-(5) so as to calculate a safety inventory amount of a common component used commonly in a plurality of products.
(1) A demand standard deviation concerning time variation of demand for each of the plurality of products, identification of components used in each of the plurality of products and respective numbers of the components used in the product in question, and time-dependent demand records for each of the plurality of products are received.
(2) A required-amount standard deviation of the common component for each of the plurality of products is obtained by using the number of the common component used in the product in question and the demand standard deviation for the product.
(3) A required-amount record (i.e. actual required-amount) of the common component for each of the plurality of products is obtained based on the demand record of each of the plurality of product and the number of the common component used in each of the plurality of product; correlation coefficients indicating correlations between required-amounts of the common component for the plurality of products are obtained based on the required-amount records of the common component used in the plurality of products; and an integrated required-amount standard deviation (i.e. a required-amount standard deviation of the common component for all of the plurality of product, which is obtained by integrating the respective required-amount standard deviations) is obtained by using the correlation coefficients and the respective required-amount standard deviations of the common component for the plurality of products.
(4) A safety inventory amount of the common component is obtained by using the integrated required-amount standard deviation.
(5) The safety inventory amount of the common component is outputted.

Here, when the integrated required-amount standard deviation is obtained (3), it is favorable to execute the following (3-1)-(3-4).
(3-1) Any two products are selected out of the plurality of products.
(3-2) The required-amount record of the common component for each of the two products is obtained based on the demand records of the two products and the respective numbers of the common component used in the two products. And, the correlation coefficient indicating a correlation between the respective required-amounts of the common component for the two products is obtained based on the respective required-amount records of the common component for the two products.
(3-3) A primary integrated required-amount standard deviation is obtained by integrating the respective required-amount standard deviations of the common component for the two products by using the required-amount standard deviations for the two products and the correlation coefficient between the required-amounts of the common component for the two products.
(3-4) The two products (for which the primary integrated required-amount standard deviation has been obtained) is virtually taken as one product. And, the selection step, the coefficient calculation step and the primary integrated deviation calculation step are executed repeatedly until two products cannot be selected in the selection step. The primary integrated required-amount standard deviation obtained last in the primary integrated deviation calculation step is determined as the integrated required-amount standard deviation.

Demands for a plurality of products have some mutual relationship between them. For example, a sale of a product (a main unit) has often a certain correlation with a sale of an option (an optional product) of that product. In that case, it can be said that there is a positive correlation between demands for these products. On the contrary, there is a case where, when one product in the group sells well, sales of the other products in the group come down. In that case, it can be said that there is a negative correlation between demands for these products.

As for a safety inventory amount of a common component used in a plurality of products having such a correlation, a relatively small amount of safety inventory is sufficient in the case where demands for the products have a negative correlation, because amounts of the used component tend to vary in the reverse direction to each other. On the other hand, in the case where demands for the products have a positive correlation, amounts of the component used becomes larger. Accordingly, if a correlation between demands for a plurality of goods is not taken into consideration, risk of occurrence of excess or deficiency of a component becomes higher. In contrast, the present invention considers a correlation between demands for a plurality of products in order to obtain a safety inventory amount of a common component used in the products. Thus, it is possible to obtain an accurate safety inventory amount of a common component, and as a result excess or deficiency of the component can be kept to the minimum.

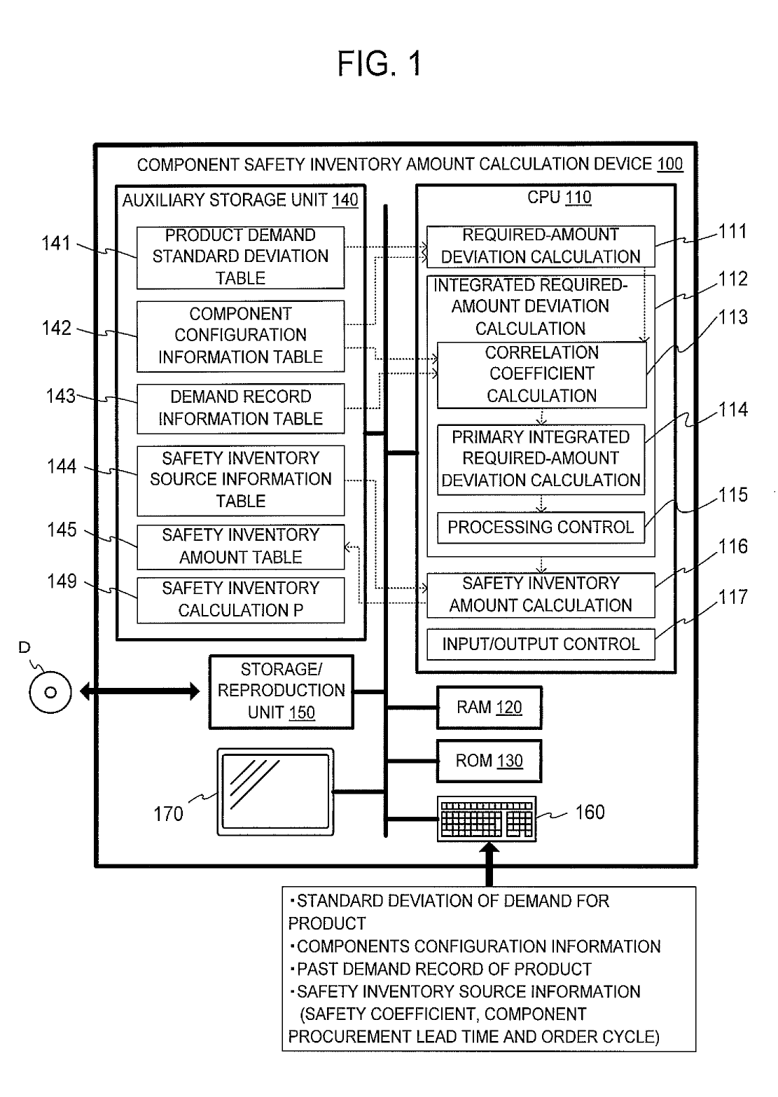

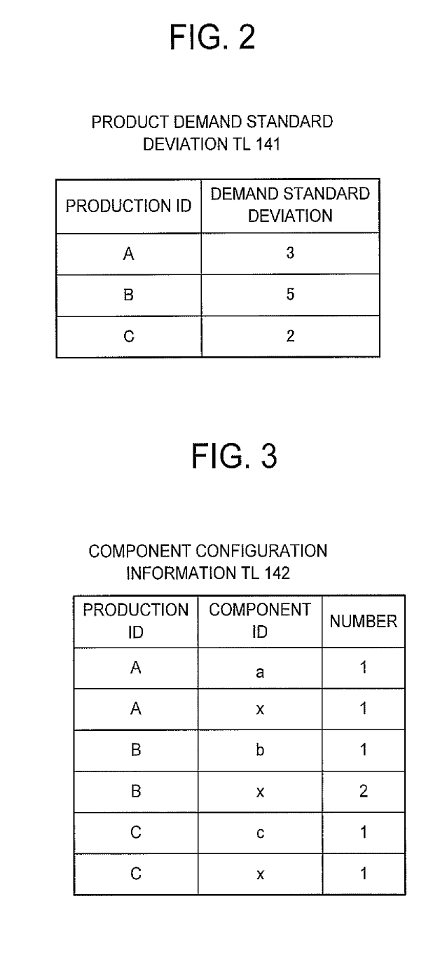

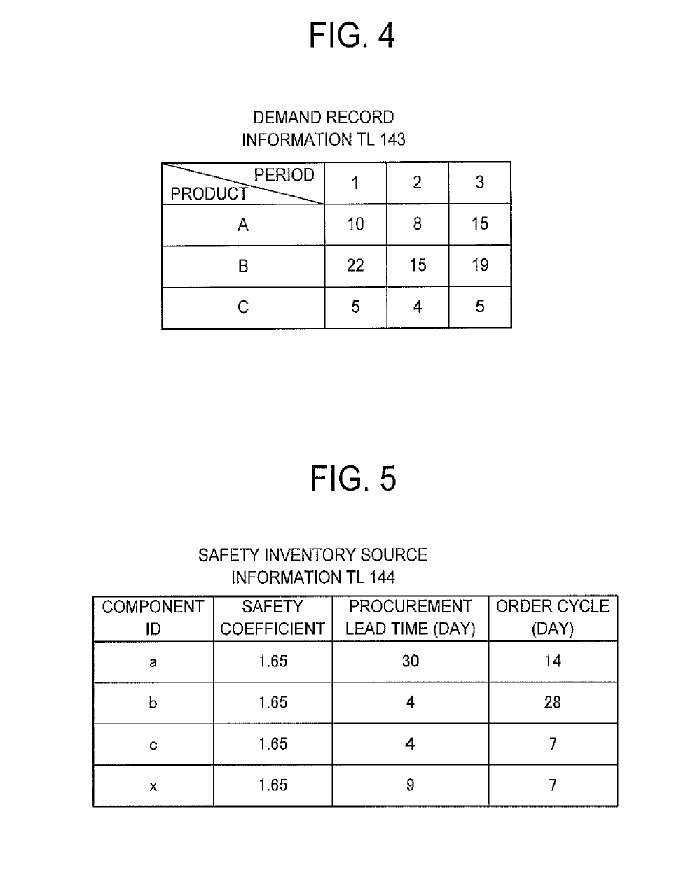

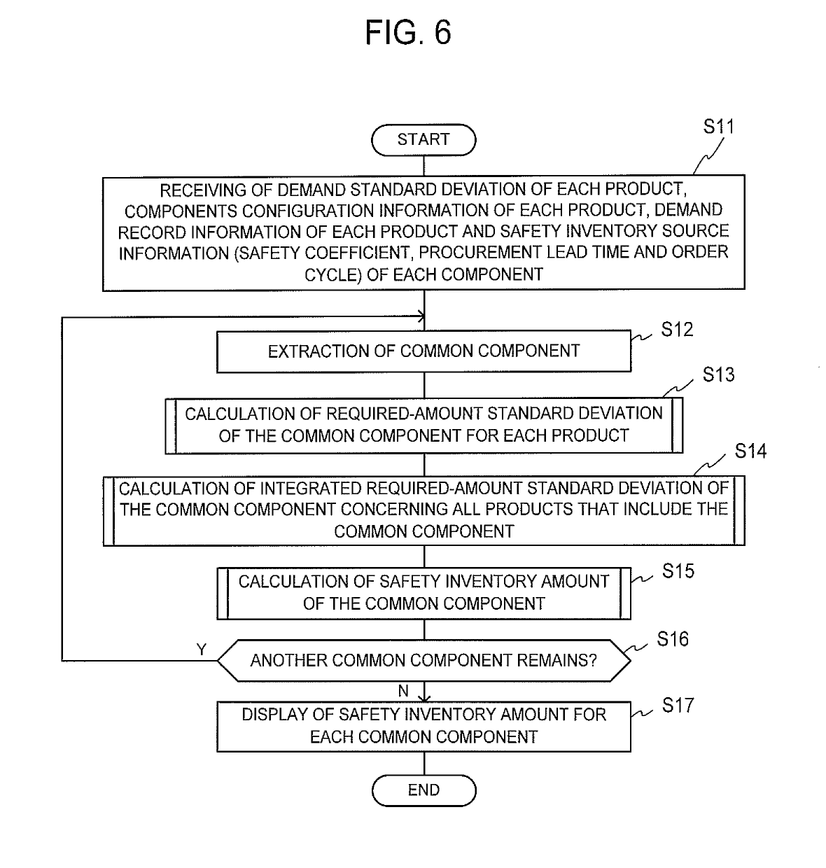

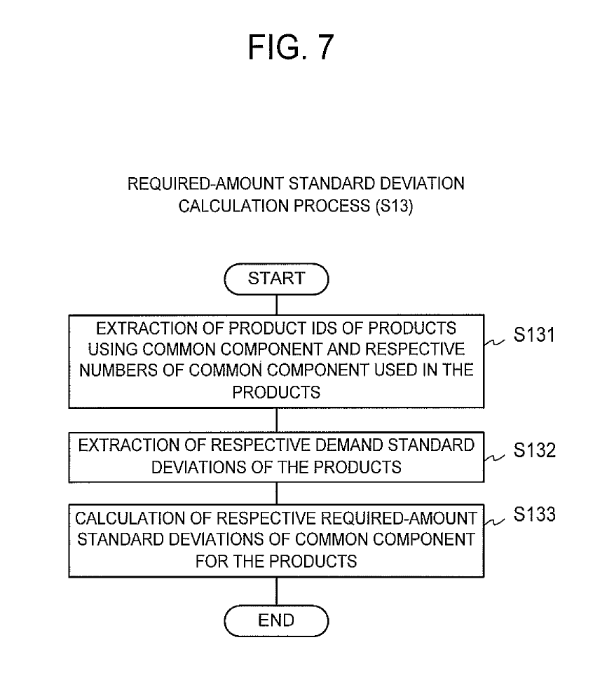

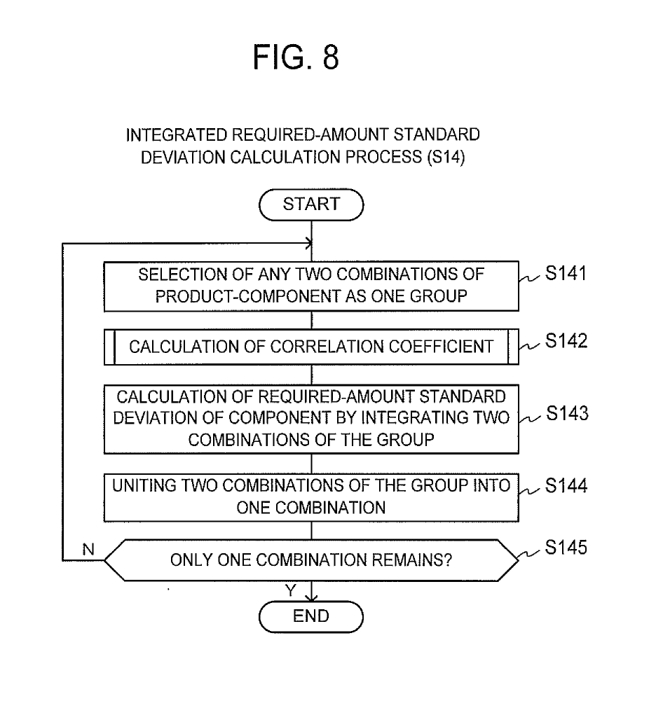

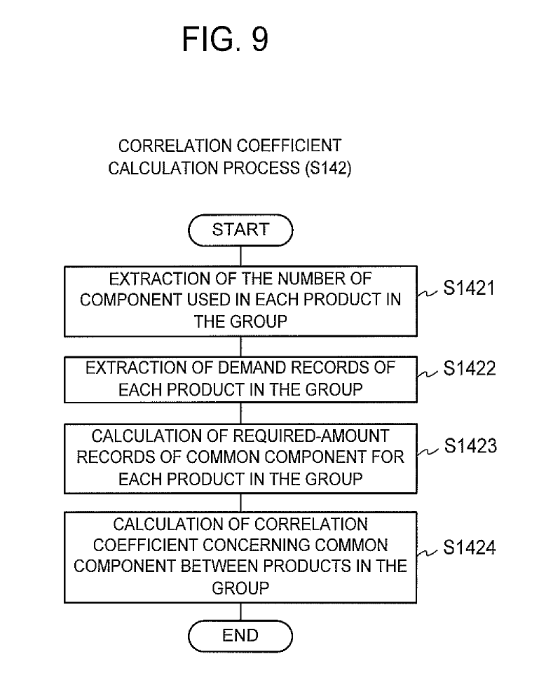

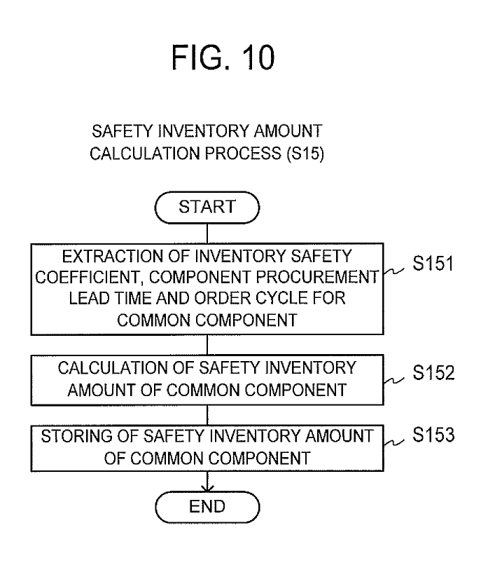

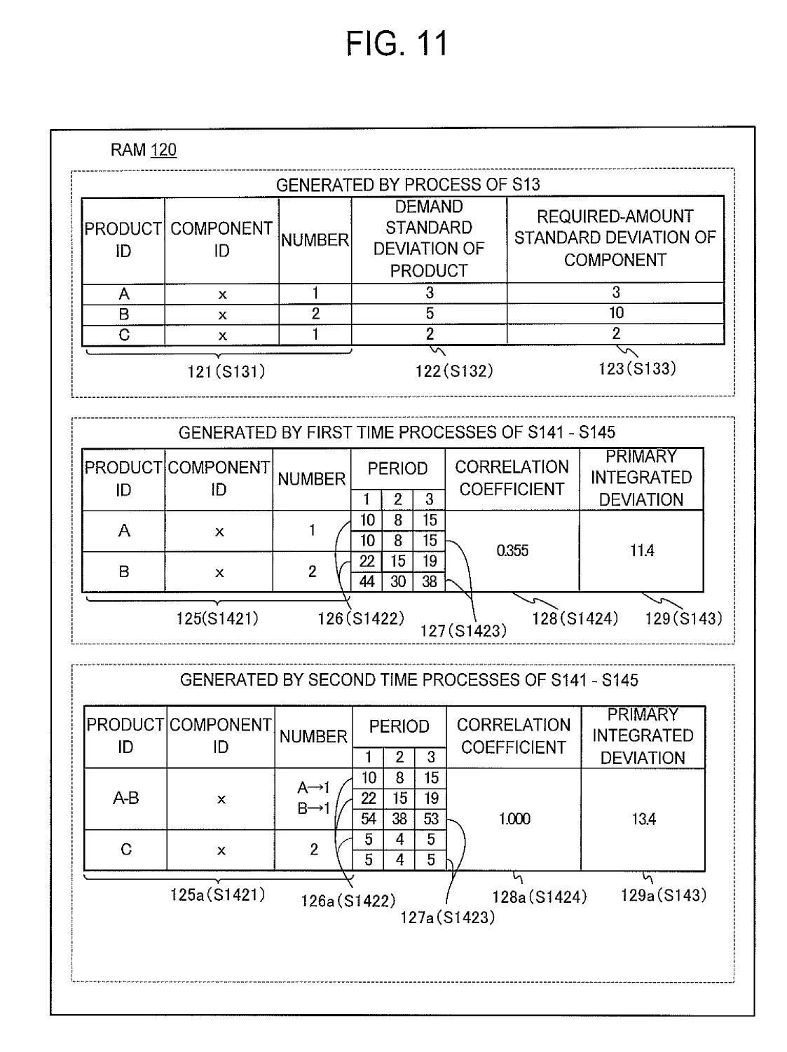

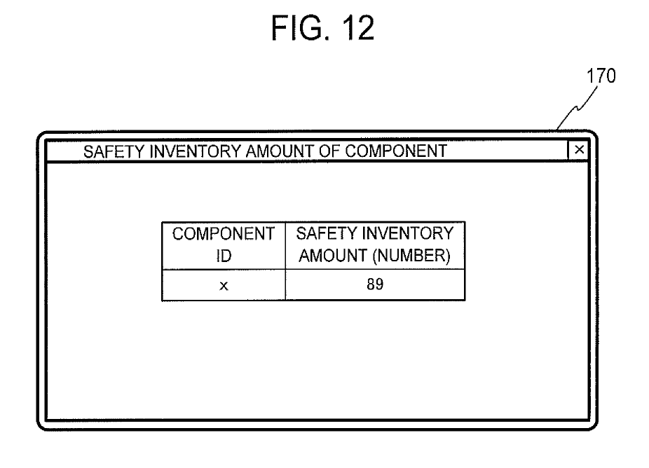

### BRIEF DESCRIPTION OF DRAWINGS

[FIG 1] A block diagram showing a configuration of a component safety inventory amount calculation device as an embodiment of the present invention.

[FIG. 2] An explanatory diagram showing data structure of a component demand standard deviation table as an embodiment of the present invention.

[FIG. 3] An explanatory diagram showing data structure of a component configuration information table as an embodiment of the present invention.

[FIG. 4] An explanatory diagram showing data structure of a demand record information table as an embodiment of the present invention.

[FIG. 5] An explanatory diagram showing data structure of a safety inventory source information table as an embodiment of the present invention.

[FIG. 6] A flowchart showing operation of a calculation device as an embodiment of the present invention.

[FIG. 7] A flowchart showing details of the required-amount standard deviation calculation process (S13) in FIG. 6.

[FIG. 8] A flowchart showing details of the integrated required amount standard deviation calculation process (S14) in FIG. 6.

[FIG. 9] A flowchart showing details of the correlation coefficient calculation process (S142) in FIG. 8.

[FIG. 10] A flowchart showing details of the safety inventory amount calculation process (S15) in FIG. 6.

[FIG. 11] An explanatory diagram showing data arranged in a RAM of a calculation device as an embodiment of the present invention.

[FIG. 12] An explanatory view showing an example of display of safety inventory amount, as an embodiment of the present invention.

### BEST MODE FOR CARRYING OUT THE INVENTION

Now, an embodiment of a component safety inventory amount calculation device according to the present invention will be described referring to drawings.

As shown in FIG. 1, the component safety inventory amount calculation device 100 of the present embodiment is a computer, which comprises: a CPU 110 that executes various types of processing; a RAM 120 that becomes a work area or the like for the CPU 110; a ROM 130 that stores various data; an auxiliary storage unit 140 such as a hard disk drive or a Solid State Drive (SSD) unit including a flash memory; a storage/reproduction unit 150 that stores and reproduces data to and from a portable storage medium D such as a CD or DVD; an input unit 160 such as a keyboard or a mouse; and a display unit 170 such as a CRT display, a Liquid Crystal (LC) Display, or an organic Electro-Luminescence (EL) display.

The auxiliary storage unit 140 stores: a product demand standard deviation table 141 for storing, for each product, a demand standard deviation concerning time variation in the past; a component configuration information table 142 for storing component configuration information for each product; a demand record information table 143 for storing past demand record information for each product; a safety inventory source information table 144 for storing safety inventory source information (a component inventory safety coefficient, a component procurement lead time, and a component order cycle), i.e. parameters required for obtaining a safety inventory amount of a component; and a safety inventory amount table 145 for storing a safety inventory amount of a component. Further, the auxiliary storage unit 140 stores a safety inventory calculation program 149 for obtaining a safety inventory amount of a component. As for the safety inventory calculation program 149, it is possible that the program 149 stored in a portable storage medium D is reproduced by the storage/reproduction unit 150 and stored in the auxiliary storage unit 140. Or, the safety inventory calculation program 149 may be obtained from the outside through a communication device (not shown in the figure) and then stored in the auxiliary storage unit 140. Further, the product demand standard deviation table 141, the component configuration information table 142, the demand record information table 143 and the safety inventory source information table 144 may be stored in the RAM 120.

The CPU 110 functionally comprises: a required-amount deviation calculating section 111 for obtaining a required-amount standard deviation of a component of each product by using a demand standard deviation and the like of the product; an integrated required-amount deviation calculating section 112 for obtaining an integrated required-amount standard deviation by integrating respective required-amount standard deviations of a common component to products; a safety inventory amount calculating section 116 for obtaining a safety inventory amount of the common component by using the integrated required-amount standard deviation and the like; and an input/output control section 117. The integrated required-amount deviation calculating section 112 comprises: a correlation coefficient calculating block 113 for obtaining a correlation coefficient indicating a correlation between amounts of the common component required respectively for two products; a primary integrated required-amount deviation calculating block 114 for integrating required-amount standard deviations of the common component to two products; and a processing control block 115 for controlling processing in the correlation coefficient calculating block 113 and the primary integrated required-amount deviation calculating block 115.

Each of the functional sections 111-117 operates when the CPU 110 reads the safety inventory calculation program 149 from the auxiliary storage unit 140, loads the program 149 into the RAM 120, and executes the program 149.

Next, operation of the above-described component safety inventory amount calculation device 100 will be described referring to the flowcharts shown in FIGS. 6-10.

First, the input/output control section 117 receives the demand standard deviation of each product, the component configuration information of each product, the demand record information of each product, and the safety inventory source information of each component. Then, the input/output control section 117 stores these pieces of information respectively in the product demand standard deviation table 141, the component configuration information table 142, the demand record information table 143, and the safety inventory source information table 144 (S11). Here, as an input means for each piece of information, the input unit 160 such as a keyboard is shown as an example. This input means may be storage/reproduction unit 150 or a communication device (not shown). That is to say, various types of information stored in a portable storage medium D may be reproduced by the storage/reproduction unit 150 so that the input/output control section 117 may receive those various types of information. Or, various types of information may be received through a communication device so that the input/output control section 117 receives those various types of information.

As shown in FIG. 2, the product demand standard deviation table 141 has a product ID area for storing a product ID and a demand standard deviation area for storing a demand standard deviation. The input/output control section 117 receives, for each product, a product ID and a demand standard deviation of the product from the input unit 160, and stores them in the corresponding areas of the product demand standard deviation table 141.

As shown in FIG. 3, the component configuration information table 142 has a product ID area for storing a product ID, a component ID area for storing a component ID, and a number area for storing the number of the component. The input/output control section 117 receives, for each product, a product ID, component IDs of all components constituting the product, and the number of each component used in the product from the input unit 160, and stores them in the corresponding areas of the component configuration information table 142.

Here, for easier comprehension of the following description, it is assumed that: products under consideration are three kinds of products having respective IDs “A”, “B” and “C”; components used in some one of these products are four kinds of components having respective IDs “a”, “b”, “c” and “x”; and the component having ID “x” is the only component used commonly in these products. Further, in the following, a safety inventory amount of the common component “x” is obtained.

As shown in FIG. 4, the demand record information table 143 has an ID area for storing a product ID and a demand amount area for storing a demanded amount of a product in each period in the past. The input/output control section 117 receives a product ID of each product and a demand amount of that product in each period from the input unit 160, and stores them in the corresponding areas of the demand record information table 143.

As shown in FIG. 5, the safety inventory source information table 144 has a component ID area for storing a component ID, a safety coefficient area for storing a safety coefficient of a component, a procurement lead time area for storing a procurement lead time of a component, and an order cycle area for storing an order cycle of a component. The input/output control section 117 receives, from the input unit 160, a component ID of each component, an inventory safety coefficient of the component, a procurement lead time of the component and an order cycle of the component, and stores them in the corresponding areas of the safety inventory source information table 144.

Here, the inventory safety coefficient means a in a variable z defined by a·σ (σ: standard deviation) with respect to a normal distribution of an inventory amount. For example, an inventory safety coefficient required for obtaining an inventory out-of-stock rate of 5% is 1.65, because the variable z is 1.65·σ for attaining an inventory existence rate of 95%.

Further, the procurement lead time of a component means a time (day) elapsing from an order of the component to its delivery, and the order cycle of a component means a time (day) between an order of the component and its next order.

Next, the required-amount deviation calculating section 111 extracts a common component “x” common to all the products “A”, “B” and “C” from the component configuration information table 142 (FIG. 3) (S12).

Then, the required-amount deviation calculating section 111 calculates, for each product, a standard deviation of a required-amount of the common component “x” (S13).

Here, details of the required-amount standard deviation calculation process (S13) will be described referring to the flowchart shown in FIG. 7.

First, from the component configuration information table 142 (FIG. 3), the required-amount deviation calculating section 111 extracts the product IDs “A”, “B” and “C” of the products using the common component “x” and the numbers “1”, “2” and “1” of the common component “x” used in those products. Then, as shown in FIG. 11, the required-amount deviation calculating section 111 arranges these data 121 in the RAM 120 (S131).

Next, the required-amount deviation calculating section 111 extracts, from the product demand standard deviation table 141 (FIG. 2), the respective demand standard deviations “3”, “5” and “2” of the products “A”, “B” and “C”, and arranges these demand standard deviations “3”, “5” and “2” 122 in the RAM 120, associating them with the respective product IDs arranged previously in the RAM 120 (S132).

Last, the required-amount deviation calculating section 111 multiplies the demand standard deviation of each product by the relevant number of the common component “x”, to obtain the required-amount standard deviations “3”, “10” and “2” of the common component “x” in these products, and arranges these required-amount standard deviations “3”, “10” and “2” 123 in the RAM 120, associating them with the respective product IDs arranged previously in the RAM 120 (S133). For example, as shown in FIG. 11, in the case of the product “B”, the demand standard deviation “5” of this product “B” is multiplied by the number “2” of the common component “x” used in the product “B”, to obtain a required-amount standard deviation “10(=5*2)”.

This ends the required-amount standard deviation calculation process (S13).

Description will be given, returning again to the flowchart shown in FIG. 6.

When the required-amount standard deviation calculation process (S13) ends, the integrated required-amount deviation calculating section 112 integrates the required-amount standard deviations of the respective common component “x” regarding all the products “A”, “B” and “C” using the common component “x”, to calculate a required-amount standard deviation of the common component “x” regarding all the products, i.e. an integrated required-amount standard deviation (S14).

Here, details of the integrated required-amount standard deviation calculation process (S14) will be described referring to the flowchart shown in FIG. 8.

First, the processing control block 115 of the integrated required-amount deviation calculating section 112 selects arbitrary two products as one group out of all the products “A”, “B” and “C” using the common component “x”. In other words, out of a combination of the common component “x” and the product “A”, a combination of the common component “x” and the product “B” and a combination of the common component “x” and the product “C”, arbitrary two combinations are selected as one group (S141). Here, it is assumed that the processing control block 115 selects two combinations, the combination of the common component “x” and the product “A” and the combination of the common component “x” and the product “B”, as one group.

Next, the correlation coefficient calculating block 113 of the integrated required-amount deviation calculating section 112 calculates a correlation coefficient that indicates a correlation between the required amounts of the common component of the two products (S142).

Here, details of the correlation coefficient calculation process (S142) will be described referring to the flowchart shown in FIG. 9.

First, the correlation coefficient calculating block 113 of the integrated required-amount deviation calculating section 112 extracts the respective numbers of the common component “x” used in the products in the group from the component configuration information table 142 (FIG. 3), and arranges in the RAM 120 the data 125 of the product IDs “A” and “B”, the component IDs “x” and “x” and the numbers “1” and “2” as shown in FIG. 11 (S1421).

Next, the correlation coefficient calculating block 113 extracts the demand records of (i.e. actual demands for) each product in the group, and arranges these demand records 126 in the RAM 120, associating them with the respective product IDs arranged previously in the RAM 120 (S1422).

Next, for each product in the group, the correlation coefficient calculating block 113 multiplies a demand record of the product by the number of the common component “x” used in the product in order to calculate a required-amount record of the common component “x” in this product. And, as shown in FIG. 11, the correlation coefficient calculating block 113 arranges in the RAM 120 these required-amount records 127, associating them with the respective product IDs arranged previously in the RAM 120 (S1423).

Last, using the required-amount records of the common component “x” regarding the products in the group, the correlation coefficient calculating block 113 calculates a correlation coefficient K of the common component “x” between the products “A” and “B” in the group according to the following [Equation 1], and arranges the correlation coefficient K 128 in the RAM 120 as shown in FIG. 11 (S1424). Here, the correlation coefficient K of the common component “x” between the products “A” and “B” in the group is “0.355”.

$$\begin{matrix}[ Equation 1 ] & \\ K = \frac{\sum ( {x}_{i} - {x}_{a} ) ( {y}_{i} - {y}_{a} )}{\sqrt{\sum {( {x}_{i} - {x}_{a} )}^{2}} \sqrt{\sum {( {y}_{i} - {y}_{a} )}^{2}}} & ( 1 )\end{matrix}$$

Here:

xᵢ: a required-amount record of one of the two products in each period;

xₐ: an arithmetic mean of the required-amount records of that one product in the periods concerned;

yᵢ: a required-amount record of the other product in each period; and

yₐ: an arithmetic mean of the required-amount records of the other product in the periods concerned.

Referring to the flowchart shown in FIG. 8 again, description will be given.

When the correlation coefficient calculation process (S142) ends, the primary integrated required-amount deviation calculating block 114 of the integrated required-amount deviation calculating section 112 calculates a primary integrated required-amount standard deviation σ_{S} of the common component “x”, which is a required-amount standard deviation of the common component “x” calculated by integrating the two combinations in the group according to the following [Equation 2] using the correlation coefficient K in the group and the respective required-amount standard deviations σₓ and σ_{y} of the common component “x” for the products in the group. Then, as shown in FIG. 11, the primary integrated required-amount deviation calculating block 114 arranges the primary integrated required-amount standard deviation σ_{S} 129 in the RAM 120 (S143). In the present embodiment, the primary integrated required-amount standard deviation σ_{S} of the common component “x” obtained by integrating the two combinations in the group is “11.4”.

[Equation 2]

σₛ=\sqrt{σₓ²σ_{y}²+2 K×σₓ×σ_{y}} (2)

Next, the processing control block 115 of the integrated required-amount deviation calculating section 112 virtually unites the two combinations in the group into one combination. In other words, the two products “A” and “B” in the group are virtually taken as one product “A-B” (S144).

Next, the processing control block 115 judges whether there remains only one combination of the common component “x” and a product (S145). When it is judged that only one combination remains, then it is judged that the integration of the required-amount standard deviations of the common component “x” for the products has been ended, and the integrated required-amount standard deviation calculation process (S14) is ended. On the other hand, when it is judged that two or more combinations remain, then the processing returns to the step S141. At this stage in the present embodiment, two combinations, i.e. the combination of the common component “x” and the product “C” and the combination of the common component “x” and the product “A-B”, exist as combinations using the common component “x”, and thus the processing returns to the step S141.

Returning to the step S141, the processing control block 115 selects a group of any two combinations out of the remaining combinations of the common component “x” and a product. In the case of the present embodiment, the remaining combinations of the common component “x” and a product are only two, i.e. the combination of the common component “x” and the product “C” and the combination of the common component “x” and the product “A-B”. Thus these two combinations are selected as a group.

Next, the coefficient correlation calculating block 113 of the integrated required-amount deviation calculating section 112 calculates a correlation coefficient that indicates a correlation between the respective required amounts of the common component “x” for the two products “C” and “A-B” (S142).

Here again, the second round of correlation coefficient calculation process (S142) will be described referring to the flowchart shown in FIG. 9.

First, in this correlation coefficient calculation process (S142) too, the correlation coefficient calculating block 113 of the integrated required-amount deviation calculating section 112 extracts the number of the common component “x” used in each product in the group from the component configuration information table 142 (FIG. 3), and arranges in the RAM 120 the data 125a of the product IDs “C” and “A-B”, the component IDs “x” and “x” and the numbers “1” and “1 (the product “A”), 2 (the product “B”)” as shown in FIG. 11 (S1421).

Next, the correlation coefficient calculating block 113 extracts the respective demand records of the products in the group, and arranges in the RAM 120 these demand records 126a, associating them with the respective product IDs arranged previously in the RAM 120 as shown in FIG. 11 (S1422).

Next, for each product in the group, the correlation coefficient calculating block 113 multiplies the demand record of the product with the number of the common component “x” used in the product in order to calculate the required-amount record of the common component “x” in this product. And as shown in FIG. 11, the correlation coefficient calculating block 113 arranges in the RAM 120 these required-amount records 127a, associating them with the respective product IDs arranged previously in the RAM 120 (S1423).

Last, using the required-amount records of the common component “x” regarding the products in the group, the correlation coefficient calculating block 113 calculates a correlation coefficient K of the common component “x” between the products “C” and “A-B” in the group according to the above [Equation 1], and arranges the correlation coefficient K 128a in the RAM 120 as shown in FIG. 11 (S1424). Here, the correlation coefficient K of the common component “x” between the products “C” and “A-B” in the group is “1.000”.

This ends the second round of correlation coefficient calculation process (S142).

Again, description will be given referring to the flowchart shown in FIG. 8.

When the second round of correlation coefficient calculation process (S142) ends, the primary integrated required-amount deviation calculating block 114 of the integrated required-amount deviation calculating section 112 calculates a primary integrated required-amount standard deviation σ_{S} of the common component “x” by integrating the two combinations in the group according to the above [Equation 2] using the correlation coefficient K in the group and the respective required-amount standard deviations σₓ and σ_{y} of the common component “x” for the products in the group. Then, as shown in FIG. 11, the primary integrated required-amount deviation calculating block 114 arranges the primary integrated required-amount standard deviation σ_{S} 129a in the RAM 120 (S143). In the present embodiment, the primary integrated required-amount standard deviation σ_{S} of the common component “x” obtained by integrating the two combinations in the group is “13.4”.

Next, the processing control block 115 of the integrated required-amount deviation calculating section 112 virtually unites the two combinations in the group into one combination. In other words, here the two products “C” and “A-B” in the group are virtually taken as one product “A-B-C” (S144).

Next, the processing control block 115 judges whether there remains only one combination of the common component “x” and a product (S145). At this stage in the present embodiment, only one combination, i.e. the combination of the common component “x” and the product “A-B-C”, exists as a combination using the common component “x”. Thus, the finally-obtained primary integrated required-amount standard deviation “13.4” is taken as the required-amount standard deviation of the common component “x” regarding all the products, i.e. the integrated required-amount standard deviation σ_{I}, and this integrated required-amount standard deviation calculation process (S14) is ended.

Again, description will be given referring to the flowchart shown in FIG. 6.

When the integrated required-amount standard deviation calculation process (S14) ends, a safety inventory amount of the common component “x” is calculated (S15).

Here, details of the safety inventory amount calculation process (S15) will be described referring to the flowchart shown in FIG. 10.

First, the safety inventory amount calculating section 116 extracts the inventory safety coefficient k_{S} of the common component “x”, its procurement lead time T and its order cycle S from the safety inventory source information table 144 (FIG. 5) (S151).

Next, the safety inventory amount calculating section 116 calculates the safety inventory amount S_{S} according to the following [Equation 3], using the integrated required-amount standard deviation σ_{I} calculated in the step S14, and the inventory safety coefficient k_{S}, the procurement lead time T and the order cycle S of the common component “x”, which were extracted in the step S151 (S152). In the present embodiment, the safety inventory amount S_{S} becomes “89”.

[Equation 3]

S_{S}=kₛ×σ_{I}×\sqrt{T×S} (3)

Last, the safety inventory amount calculating section 116 stores the calculated safety inventory amount S_{S} in the safety inventory amount table 145, associating the safety inventory amount S_{S} with the ID “x” of the common component (S153)

This ends the safety inventory amount calculation process (S15).

Again, description will be given referring to the flowchart shown in FIG. 6.

When the safety inventory amount calculation process (S15) ends, the required-amount deviation calculating section 111 judges whether there remains a common component that has not been dealt with (S16). If there remains a common component that has not been dealt with, the processing returns to the step S12 to extract a remaining common component. On the other hand, if there does not remain a common component that has not been dealt with, the input/output control section 117 extracts the safety inventory amount for each common component ID from the safety inventory amount table 145, and, as shown in FIG. 12, makes the display unit 170 display the safety inventory amount (“89”) for each common component ID. Although the display unit 170 is here mentioned as an example of an output means for the safety inventory amount, the output means may be the storage/reproduction unit 150, a communication unit (not shown) or a printer (not shown). That is to say, the safety inventory amount may be stored in a portable storage medium D through the storage/reproduction unit 150. Or the safety inventory amount may be printed by a printer or sent to the outside through a communication unit.

This is the end of a series of operation of the component safety inventory amount calculation device 100.

Demands for a plurality of products have some mutual relationship between them. For example, a sale of a product (a main unit) has often a certain correlation with a sale of an option (an optional product) of that product. In that case, it can be said that there is a positive correlation between demands for these products. On the contrary, there is a case where, when one product in the group sells well, sales of the other products in the group come down. In that case, it can be said that there is a negative correlation between demands for these products.

As for a safety inventory amount of a common component used in a plurality of products having such a correlation, a relatively small amount of safety inventory is sufficient in the case where demands for the products have a negative correlation, because amounts of the used component tend to vary in the reverse direction to each other. On the other hand, in the case where demands for the products have a positive correlation, amounts of the component used becomes larger. Accordingly, if a correlation between demands for a plurality of goods is not taken into consideration, risk of occurrence of excess or deficiency of a component becomes higher. In contrast, the present embodiment considers a correlation between demands for a plurality of products in order to obtain a safety inventory amount of a common component used in the products. Thus, it is possible to obtain an accurate safety inventory amount of a common component, and as a result excess or deficiency of the component can be kept to the minimum. Thus, it is possible to reduce work burden of adjusting the safety inventory amount in a manufacturer of the products.

Hereinabove, the present invention has been described in relation to the embodiment as an example. It will be obvious to persons skilled in the art that many substitutes, modifications and variations can be realized. Thus, the above-described embodiment of the present invention is intended to give an example not to limit the scope of the present invention.

For example, in the above-described embodiment of the present invention, a standard deviation of each product, which is stored in the demand standard deviation storage section, is not data for each period. In practice, however, a safety inventory amount may be calculated as data for each data.

1. A safety inventory amount calculation device for calculating a safety inventory amount of a common component used commonly in a plurality of products, comprising:
a receiving means, which receives a demand standard deviation concerning time variation of demand for each of the plurality of products, identification of components used in each of the plurality of products and respective numbers of the components used in the product in question, and time-dependent demand records for each of the plurality of products;
a storage means, which stores the demand standard deviation concerning the time variation of demand for each of the plurality of products, identification of the components used in each of the plurality of products and the respective numbers of the components, and the time-dependent demand records for each of the plurality of products as a result of the time variation, wherein the demand standard deviation, the identification and the respective numbers of the components, and the demand records have been received by the receiving means;
a deviation calculation means, which obtains a required-amount standard deviation of the common component for each of the plurality of products by using the number of the common component used in the product in question and the demand standard deviation for the product;
an integrated deviation calculation means, which: obtains a required-amount record of the common component for each of the plurality of products based on the demand record of each of the plurality of product and the number of the common component used in each of the plurality of product; obtains correlation coefficients indicating correlations between required-amounts of the common component for the plurality of products based on the required-amount records of the common component used in the plurality of products; and obtains an integrated required-amount standard deviation (i.e. a required-amount standard deviation of the common component for all of the plurality of product, which is obtained by integrating the respective required-amount standard deviations) by using the correlation coefficients and the respective required-amount standard deviations of the common component for the plurality of products;
a safety inventory amount calculation means, which obtains a safety inventory amount of the common component by using the integrated required-amount standard deviation, and stores the safety inventory amount in the storage means; and
an output means, which outputs the safety inventory amount of the common component.

2. A safety inventory amount calculation device of claim 1, wherein:
the integrated deviation calculation means comprises:
a selection means, which selects any two products out of the plurality of products;
a coefficient calculation means, which obtains the required-amount record of the common component for each of the two products based on the demand records of the two products and the respective numbers of the common component used in the two products, and obtains the correlation coefficient indicating a correlation between the respective required-amounts of the common component for the two products based on the respective required-amount records of the common component for the two products;
a primary integrated deviation calculation means, which obtains a primary integrated required-amount standard deviation which is acquired by integrating the respective required-amount standard deviations of the common component for the two products by using the required-amount standard deviations for the two products and the correlation coefficient between the required-amounts of the common component for the two products; and
a processing control means, which: takes the two products (for which the primary integrated required-amount standard deviation has been obtained) virtually as one product; makes processing in the selection means, the coefficient calculation means and the primary integrated deviation calculation means be executed repeatedly until the selection means cannot select two products; and determines that the primary integrated required-amount standard deviation obtained last by the primary integrated deviation calculation means is the integrated required-amount standard deviation.

3. A safety inventory amount calculation device of claim 2, wherein:
the receiving means receives an inventory safety coefficient of the common component, a procurement lead time of the common component and an order cycle of the common component, and stores the inventory safety coefficient, the procurement lead time and the order cycle in the storage means; and
the safety inventory amount calculation means obtains the safety inventory amount of the common component by using the integrated required-amount standard deviation, the inventory safety coefficient of the common component, the procurement lead time of the common component and the order cycle of the common component.

4. A safety inventory amount calculation device of claim 3, wherein:
the safety inventory amount calculation means obtains the safety inventory amount S_{S} of the common component according to a following Equation 1,
[Equation 1]
S_{S}=K_{S}×σ_{I}×\sqrt{T×S} (1)
by using the integrated required-amount standard deviation σ_{I}, the inventory safety coefficient k_{S} of the common component, the procurement lead time T of the common component, and the order cycle S of the common component.

5. A safety inventory amount calculation device of one of claims 2-4, wherein:
the coefficient calculation means obtains the correlation coefficient K according to a following Equation 2,
$$\begin{matrix}[ Equation 2 ] & \\ K = \frac{\sum ( {x}_{i} - {x}_{a} ) ( {y}_{i} - {y}_{a} )}{\sqrt{\sum {( {x}_{i} - {x}_{a} )}^{2}} \sqrt{\sum {( {y}_{i} - {y}_{a} )}^{2}}} & ( 2 )\end{matrix}$$
in which:
xᵢ: a required-amount record of one of the two product in each period;
xₐ: an arithmetic mean of the required-amount records of that one product in periods concerned;
yᵢ: a required-amount record of the other product in each period; and
yₐ: an arithmetic mean of the required-amount records of the other product in the periods concerned.

6. A safety inventory amount calculation device of one of claims 2-5, wherein:
the primary integrated deviation calculation means obtains the primary integrated required-amount standard deviation σ_{S} according to a following Equation 3,
[Equation 3]
σₛ×\sqrt{σₓ²σ_{y}²+2 K×σₓ×σ_{y}} (3)
by using the correlation coefficient K for the two products and the respective required-amount standard deviations σₓ and σ_{y} of the common component for the two products.

7. A safety inventory amount calculation program for calculating a safety inventory amount of a common component used commonly in a plurality of products, wherein the safety inventory amount calculation program makes a computer execute:
a receiving step, in which an input means of the computer receives a demand standard deviation concerning time variation of demand for each of the plurality of products, identification of components used in each of the plurality of products and respective numbers of the components used in the product in question, and time-dependent demand records for each of the plurality of products; and the demand standard deviation, the identification of the components used in each of the plurality of products and the respective numbers of the components and the demand records are stored in a storage means of the computer;
a deviation calculation step, in which a required-amount standard deviation of the common component for each of the plurality of products is obtained by using the number of the common component used in the product in question and the demand standard deviation for the product;
an integrated deviation calculation step, in which: a required-amount record of the common component for each of the plurality of products is obtained based on the demand record of each of the plurality of product and the number of the common component used in each of the plurality of product; correlation coefficients indicating correlations between required-amounts of the common component for the plurality of products are obtained based on the required-amount records of the common component used in the plurality of products; and an integrated required-amount standard deviation (i.e. a required-amount standard deviation of the common component for all of the plurality of product, which is obtained by integrating the respective required-amount standard deviations) is obtained by using the correlation coefficients and the respective required-amount standard deviations of the common component for the plurality of products;
a safety inventory amount calculation step, in which a safety inventory amount of the common component is obtained by using the integrated required-amount standard deviation, and the safety inventory amount is stored in the storage means; and
an output step, in which the safety inventory amount of the common component is outputted to an output means of the computer.

8. A safety inventory amount calculation program of claim 7, wherein, in the integrated deviation calculation step, the computer is made to execute:
a selection step, in which any two products are selected out of the plurality of products;
a coefficient calculation step, in which the required-amount record of the common component for each of the two products is obtained based on the demand records of the two products and the respective numbers of the common component used in the two products; and the correlation coefficient indicating a correlation between the respective required-amounts of the common component for the two products is obtained based on the respective required-amount records of the common component for the two products;
a primary integrated deviation calculation step, in which a primary integrated required-amount standard deviation is obtained by integrating the respective required-amount standard deviations of the common component for the two products by using the required-amount standard deviations of the common component for the two products and the correlation coefficient between the required-amounts of the common component for the two products; and
a processing control step, in which: the two products (for which the primary integrated required-amount standard deviation has been obtained) is virtually taken as one product; the selection step, the coefficient calculation step and the primary integrated deviation calculation step are executed repeatedly until two products cannot be selected in the selection step; and the primary integrated required-amount standard deviation obtained last in the primary integrated deviation calculation step is determined as the integrated required-amount standard deviation.

9. A safety inventory amount calculation program of one of claims 7 and 8, wherein:
in the receiving step, an inventory safety coefficient of the common component, a procurement lead time of the common component and an order cycle of the common component are received; and
in the safety inventory amount calculation step, the safety inventory amount of the common component is obtained by using the integrated required-amount standard deviation, the inventory safety coefficient of the common component, the procurement lead time of the common component and the order cycle of the common component.

10. A safety inventory amount calculation method for calculating a safety inventory amount of a common component used commonly in a plurality of products, wherein a computer executes:
a receiving step, in which an input means of the computer receives a demand standard deviation concerning time variation of demand for each of the plurality of products, identification of components used in each of the plurality of products and respective numbers of the components used in the product in question, and time-dependent demand records for each of the plurality of products; and the demand standard deviation, the identification of the components used in each of the plurality of products and the respective numbers of the components and the demand records are stored in a storage means of the computer;
a deviation calculation step, in which a required-amount standard deviation of the common component for each of the plurality of products is obtained by using the number of the common component used in the product in question and the demand standard deviation for the product;
an integrated deviation calculation step, in which: a required-amount record of the common component for each of the plurality of products is obtained based on the demand record of each of the plurality of product and the number of the common component used in each of the plurality of product; correlation coefficients indicating correlations between required-amounts of the common component for the plurality of products are obtained based on the required-amount records of the common component used in the plurality of products; and an integrated required-amount standard deviation (i.e. a required-amount standard deviation of the common component for all of the plurality of product, which is obtained by integrating the respective required-amount standard deviations) is obtained by using the correlation coefficients and the respective required-amount standard deviations of the common component for the plurality of products;
a safety inventory amount calculation step, in which a safety inventory amount of the common component is obtained by using the integrated required-amount standard deviation, and the safety inventory amount is stored in the storage means; and
an output step, in which the safety inventory amount of the common component is outputted to an output means of the computer.

11. A safety inventory amount calculation method of claim 10, wherein, in the integrated deviation calculation step, the computer executes:
a selection step, in which any two products are selected out of the plurality of products;
a coefficient calculation step, in which the required-amount record of the common component for each of the two products is obtained based on the demand records of the two products and the respective numbers of the common component used in the two products; and the correlation coefficient indicating a correlation between the respective required-amounts of the common component for the two products is obtained based on the respective required-amount records of the common component for the two products;
a primary integrated deviation calculation step, in which a primary integrated required-amount standard deviation is obtained by integrating the respective required-amount standard deviations of the common component for the two products by using the required-amount standard deviations of the common component for the two products and the correlation coefficient between the required-amounts of the common component for the two products; and
a processing control step, in which: the two products (for which the primary integrated required-amount standard deviation has been obtained) is virtually taken as one product; the selection step, the coefficient calculation step and the primary integrated deviation calculation step are executed repeatedly until two products cannot be selected in the selection step; and the primary integrated required-amount standard deviation obtained last in the primary integrated deviation calculation step is determined as the integrated required-amount standard deviation.
